(19) United States
(12) Patent Application Publication
(10) Pub. No.: US 2015/0059336 A1
(43) Pub. Date: Mar. 5, 2015

(54) ARRANGEMENT OF AN INTERCOOLER IN AN INTAKE PIPE

(71) Applicant: BEHR GMBH & CO, KG, Stuttgart (DE)

(72) Inventors: Matthias Fehrenbach, Stuttgart (DE); Werner Helms, Esslingen (DE); Rüdiger Kölblin, Esslingen (DE); Christian Saumweber, Stuttgart (DE)

(73) Assignee: BEHR GMBH & CO. KG, Stuttgart (DE)

(21) Appl. No.: 14/394,322

(22) PCT Filed: Apr. 10, 2013
(86) PCT No.: PCT/EP2013/057519

§ 371 Date: Oct. 14, 2014

(30) Foreign Application Priority Data
Apr. 13, 2012 (DE) 10 2012 206 121.5

(51) Int. Cl. F02B 29/04

(52) U.S. Cl. CPC F02B 29/0406; F02B 29/045
USPC 60/599

(57) ABSTRACT

Arrangement of an intercooler in an intake pipe, wherein the intercooler has a cooler block through which charge air can flow and a first opening through the intake pipe, through which the intercooler can be inserted into the intake pipe, wherein the intake pipe has a second opening, which is arranged substantially opposite the first opening and can be closed by means of a housing part.

### TECHNICAL FIELD

The invention relates to an arrangement of a charge air cooler in an intake pipe, wherein the charge air cooler has a cooler block through which charge air can flow and through the intake pipe has a first opening, it being possible for the charge air cooler to be inserted into the intake pipe through said opening.

### PRIOR ART

Charge air coolers are used for cooling the charge air in charged motors. This is necessary since the intake air is heated owing to the compression in a turbocharger. This leads to a reduction in the density of the intake air. This effectively leads to a lower oxygen content in the combustion space charge.

In contrast to compression, cooling by the charge air cooler causes an increase in the density, as a result of which intake air with a high density is supplied to the combustion space of the internal combustion engine. The content of oxygen which is required for the combustion is particularly high in air with a high density.

In order to achieve the greatest possible advantage by virtue of cooling the intake air, it is expedient to position the charge air cooler as close to the inlet valves as possible, in order to avoid subsequent heating of the air as far as possible.

In modern applications in the automobile industry, the arrangement of the charge air cooler in the intake pipe of the internal combustion engine has become established for this purpose. In this case, the charge air cooler is usually inserted into the intake pipe through a lateral opening and is fastened to the intake pipe by means of a connection flange which is generally connected to the charge air cooler in a cohesive manner.

A second bearing for the charge air cooler can be provided within the intake pipe on that wall of the intake pipe which is situated opposite the insertion opening.

Solutions of this kind are currently implemented in in-line engines with three and four cylinders. The same is true in the case of internal combustion engines with V-shaped cylinder banks with six or eight cylinders.

One disadvantage of the prior art is that, owing to this manner of installation, vibrations at the intake pipe and stresses, which can be produced owing to tolerances which are not 100% between the flange of the charge air cooler and the intake pipe, are transmitted directly to the charge air cooler.

Owing to the sometimes long lengths of the charge air cooler and the fact that an exact right angle can be found between the matrix of the charge air cooler and the flange of the charge air cooler only in a very small number of cases, more or less large deflections of the charge air cooler out of the central position may occur. The longer the charge air cooler, the greater this deflection out of the central plane may be.

This can lead to considerable problems in respect of the positioning of the charge air cooler in the necessarily required second bearing on the opposite side of the intake pipe, particularly in designs with long charge air coolers and only one opening in the intake pipe.

In addition, bearing, in particular, of long charge air coolers at only two bearing points is inadequate on account of the severe vibrations which occur.

The embodiments known from the prior art have reached their limits, in particular in respect of the future use of intake pipe-integrated charge air coolers for in-line 6-cylinder engines.

### DESCRIPTION OF THE INVENTION, PROBLEM, SOLUTION AND ADVANTAGES

The problem addressed by the present invention is therefore that of providing an installation concept for intake pipe-integrated charge air coolers, which installation concept allows even long charge air coolers to be fitted in the intake pipe in a simple and secure manner. It is also an objective to provide an installation concept which is particularly advantageous for the charge air cooler in respect of the shocks which occur.

The problem addressed by the present invention is solved by an . . . having the features as claimed in claim 1. Advantageous developments of the present invention are defined in the dependent claims.

An arrangement of a charge air cooler in an intake pipe, wherein the charge air cooler has a cooler block through which charge air can flow and through the intake pipe has a first opening, it being possible for the charge air cooler to be inserted into the intake pipe through said opening, wherein the intake pipe has a second opening which is arranged such that it is situated substantially opposite the first opening and which can be closed by a housing part, is advantageous.

It is further advantageous when the charge air cooler can be fixed at the first opening in the intake pipe.

It is also preferred when that end of the charge air cooler which can be inserted into the intake pipe has a projection, and the housing part has a recess, wherein the projection and the recess can be inserted one into the other, or when that end of the charge air cooler which can be inserted into the intake pipe has a recess, and the housing part has a projection, wherein the projection and the recess can be inserted one into the other.

Owing to these refinements of the charge air cooler and of the housing part, the charge air cooler can be inserted into the housing part, and in this way fixed in its installation position.

It is also advantageous when the housing part can be connected to the intake pipe. The second opening in the intake pipe is closed and sealed off owing to the housing part being connected to the intake pipe.

In an alternative embodiment, it is advantageous when positional tolerances between the charge air cooler and the housing part can be compensated for by means of the fastening of the housing part. This can advantageously influence the assembly process. The insertion of the charge air cooler is substantially simplified in this way since tolerances which may occur can be compensated for.

It is also preferred when a sealing means can be introduced between the housing part and the intake pipe, and when a sealing means can be introduced between the flange and the intake pipe.

### BRIEF DESCRIPTION OF THE DRAWINGS

The invention will be explained in greater detail below using an exemplary embodiment with reference to the drawing. In the drawing:

FIG. 1 shows, in the left-hand half, a perspective view of an intake pipe of an internal combustion engine with a charge air cooler installed, and also, in the right-hand half, the charge air cooler in the removed state,

FIG. 2 shows a section through the center plane of the charge air cooler and of the intake pipe in the installed state shown in FIG. 1, and

FIG. 3 shows a section through the center plane of a charge air cooler and of an intake pipe in one embodiment according to the invention.

### PREFERRED EMBODIMENT OF THE INVENTION

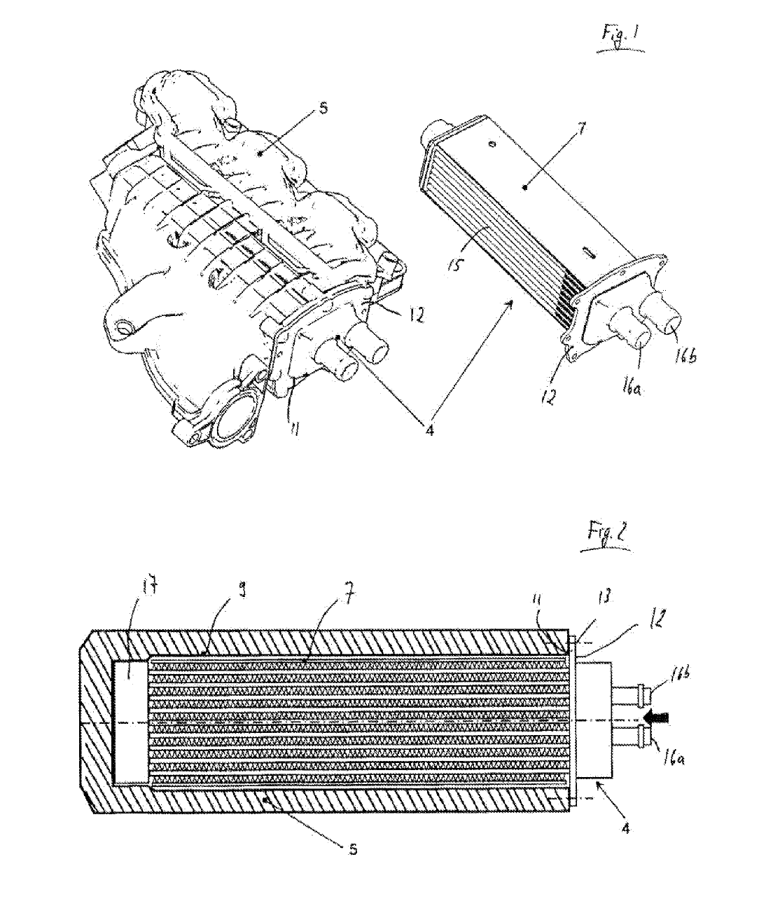

FIG. 1 shows, in the left-hand half of the image, a perspective outside view of an intake pipe 5. Said intake pipe 5 serves to supply air to an internal combustion engine, not shown in the figure. Compression of the intake air in a turbocharger or a compressor heats the air. As a result, the density of the air is reduced, and this would lead to relatively poor filling of the combustion spaces in the internal combustion engine. A charge air cooler 4 is installed in the intake pipe 5 for the purpose of cooling the air which is supplied to an internal combustion engine via the intake pipe 5, and therefore of increasing the density of the intake air.

The more precise internal design of the intake pipe 5 is not described in further detail at this point since it is not essential to the invention. The installation principle of the charge air cooler 4 in the intake pipe 5 is clear from the drawing on the left-hand side of FIG. 1.

The right-hand half of FIG. 1 shows the charge air cooler 4 which is installed in the intake pipe 5 in the left-hand half of FIG. 1. The charge air cooler 4 shown in FIG. 1 corresponds, in respect of its design, to the charge air coolers known from the prior art. In addition to a cooler block 15, which comprises a large number of cooling pipes through which coolant flows and around which air which is to be cooled flows, the charge air cooler 4 has outer walls 7.

A flange plate 12 is attached to the side of one of the header boxes of the charge air cooler 4. Said flange plate serves to fasten the charge air cooler 4 to the intake pipe 5. The charge air cooler 4 further has two coolant connection pieces 16a, 16b. A centering means 17 which serves to additionally mount the charge air cooler 4 in the intake pipe 5 is arranged at that end of the charge air cooler 4 which is situated opposite the flange plate 12.

The further detailed design of the charge air cooler is not further described at this point since it is not essential to the invention.

In further advantageous embodiments, the use of different charge air coolers of different designs is feasible. For example, the use of U-shaped charge air coolers with a deflection in the interior, but also the use of a charge air cooler through which charge air flows in a straight line without deflection, said charge air coolers having the inlet and the outlet at opposite ends.

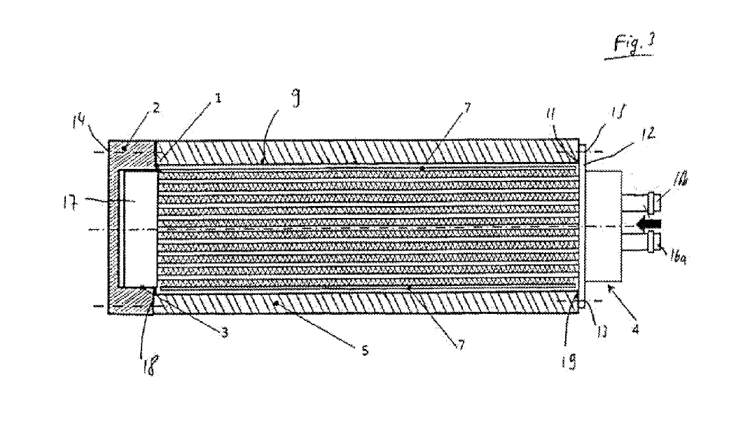

FIG. 2 shows a section through the center plane of the installed charge air cooler 4 in the intake pipe 5. Said figure shows, in particular, the section through the intake pipe 5 which has intake pipe inner walls 9. In this case, the internal region of the intake pipe 5 has dimensions which allow the charge air cooler 4 to be pushed in. A recess in the intake pipe is provided at that end of the intake pipe 5 which is situated opposite the insertion opening, said recess serving to receive the centering means 17 which is attached to one of the outer ends of the charge air cooler 4.

In alternative embodiments, it is likewise feasible for there to be other interlocking pairings between the centering means of the charge air cooler and the bearing of the housing part. For example, the charge air cooler could have a recess into which a projecting region of the housing part engages, or the charge air cooler has a spike which extends into the housing wall of the intake pipe.

In the inserted state, the flange plate 12 terminates flush with the outer wall of the change air pipe 5 and can be fixed to the intake pipe 5 by means of the screw systems 13.

The use of a sealing means 19, for example an O-ring seal, is provided in order to seal off the connection of the charge air cooler 4 to the intake pipe 5.

The cooler block 15 is therefore effectively subjected to the action of the air stream which flows in the interior of the intake pipe 5, this promoting heat transfer from the air which flows through said cooler block to the cooling medium which flows in the interior of the charge air cooler 4.

The embodiment of FIG. 2 constitutes the current state of the art with all of the disadvantages described in the introductory part.

The reference symbols in FIGS. 2 and 3 largely correspond, and deviations which are specific to a figure will be mentioned separately in the respective description of the figure.

In a departure from the intake pipe 5 illustrated in FIG. 1 and the arrangement of the intake pipe 5 and of the fitted charge air cooler 4 illustrated in FIG. 2, FIG. 3 illustrates an intake pipe 5 having two opposite openings 1, 11. The opening 1, which is situated opposite the opening 11, in the intake pipe 5 is illustrated in addition to the insertion opening 11 through which the charge air cooler is inserted into the intake pipe 5.

Said opening 1 in the intake pipe 5 is closed by a housing part 2 of the intake pipe 5. Said housing part can be fixed to the intake pipe 5 by means of screw systems 14. The housing part has, in its interior, a bearing point 3 for the centering means 17 of the charge air cooler 4. In this case, the screw systems 14 are formed by screw passage holes with an enlarged diameter, as a result of which it is possible to compensate for tolerances in the assembly plane of the housing part 3.

A sealing means 19 is arranged between the flange 12 and the intake pipe 5, and a sealing means 18 is likewise arranged between the housing part 2 and the intake pipe 5. The sealing means 18, 19 serve to improve sealing of the intake pipe 5 in order to prevent, for example, leaks and associated losses in pressure.

In alternative embodiments, other connection techniques for fixing the housing part to the intake pipe, such as riveting, adhesive bonding or clipping, amongst others, are also feasible. It is likewise possible to attach additional sealing means beneath the flange and the cover in order to prevent leaks.

In FIG. 3, the charge air cooler 4 is mounted at two points in the installed state. Firstly at the flange plate 12 of the charge air cooler 4, and secondly in the housing part 2 which is connected to the intake pipe 5. This is beneficial for the charge air cooler 4, in particular in respect of the shocks which are produced during operation of the internal combustion engine. As a result, the charge air cooler is fastened in the intake pipe 5 in a particularly shock-resistant manner, this being beneficial in respect of a relatively long service life of the charge air cooler.

On account of the centering means 17 of the charge air cooler being accommodated the housing part 2 of the intake pipe 6, it is ensured that the charge air cooler is held in a stable manner within the intake pipe 5.

In alternative embodiments, the arrangement of the bearing point between the housing part and the inserted charge air cooler can also differ from that shown here. It is likewise feasible, for example, for the housing part to have an extension which projects inward into the intake pipe and engages in a cutout in the end region of the charge air cooler. The exact configuration of the bearing pairing comprising the housing part and the charge air cooler has to be designed in an optimum manner in accordance with the intended use and the assembly process.

It is also feasible for the charge air cooler to be supported, by way of its centering means, against the intake pipe itself and for the housing part to perform only the function of closing the intake pipe.

1. An arrangement of a charge air cooler in an intake pipe, wherein the charge air cooler has a cooler block through which charge air can flow and through the intake pipe has a first opening, it being possible for the charge air cooler to be inserted into the intake pipe through said opening, wherein the intake pipe has a second opening which is arranged such that it is situated substantially opposite the first opening and which can be closed by a housing part.

2. The arrangement as claimed in claim 1, wherein the charge air cooler can be fixed at the first opening in the intake pipe.

3. The arrangement as claimed in claim 1, wherein that end of the charge air cooler which can be inserted into the intake pipe has a projection, and the housing part has a recess, wherein the projection and the recess can be inserted one into the other.

4. The arrangement as claimed in claim 1, wherein end of the charge air cooler which can be inserted into the intake pipe has a recess, and the housing part has a projection, wherein the projection and the recess can be inserted one into the other.

5. The arrangement as claimed in claim 1, wherein the housing part can be connected to the intake pipe.

6. The arrangement as claimed in claim 1, wherein positional tolerances between the charge air cooler and the housing part can be compensated for by means of the fastening of the housing part.

7. The arrangement as claimed in claim 1, wherein a sealing means can be introduced between the housing part and the intake pipe.

8. The arrangement as claimed in claim 1, wherein a sealing means can be introduced between the flange and the intake pipe.
